(19) United States
(12) Patent Application Publication
(10) Pub. No.: US 2020/0396757 A1
(43) Pub. Date: Dec. 17, 2020

(54) DOWNLINK TRANSMISSION RESOURCE ALLOCATION METHOD AND APPARATUS

(71) Applicant: HUAWEI TECHNOLOGIES CO., LTD., Shenzhen (CN)

(72) Inventors: Lei NING, Shenzhen (CN); Lang HE, Dongguan (CN); Wenjie SUN, Dongguan (CN); Aiying WANG, Shenzhen (CN)

(21) Appl. No.: 17/004,241

(22) Filed: Aug. 27, 2020

Related U.S. Application Data
(63) Continuation of application No. PCT/CN2018/077605, filed on Feb. 28, 2018.

(51) Int. Cl. H04W 72/12; H04W 72/04

(52) U.S. Cl. CPC H04W 72/1273; H04W 72/0446; H04W 72/1257

(57) ABSTRACT

This application provides a downlink transmission resource allocation method and apparatus. The method includes determining a first time domain resource length and a second time domain resource length, and adjusting the second time domain resource length if the first time domain resource length is greater than or equal to a preset threshold. The method also includes if a third time domain resource length is greater than or equal to a decreased second time domain resource length, determining the first time domain resource length as a first target time domain resource length, and determining the decreased second time domain resource length as a second target time domain resource length. A first time domain resource is used to switch from a first state to a second state, a second time domain resource is used to receive the downlink data, and a third time domain resource is used to transmit the downlink data.

### CROSS-REFERENCE TO RELATED APPLICATIONS

This application is a continuation of International Application No. PCT/CN2018/077605. filed on Feb. 28, 2018, the disclosure of which is hereby incorporated by reference in its entirety.

### TECHNICAL FIELD

Embodiments of the present invention relate to the field of communications technologies, and in particular, to a downlink transmission resource allocation method and apparatus.

### BACKGROUND

With rapid development of communications technologies, application of the interact of things (IoT) has become increasingly extensive. To ensure efficient communication between objects in an internet of things system, allocation of transmission resources in the internet of things system is critical.

Currently, in the narrowband internet of things (NB-IoT), a base station may allocate transmission resources to each object (for example, a terminal) in the NB-IoT. In a process in which the base station allocates downlink transmission resources to the terminal in the NB-IoT system, an example in which the base station allocates the downlink transmission resources to one terminal is used. The allocating, by the base station, the downlink transmission resources to the terminal includes: allocating, by the base station to the terminal, a time domain resource I used by the terminal to receive scheduling information, a time domain resource 2 used by the terminal to switch from a state of receiving the scheduling information to a state of receiving downlink data, a time domain resource 3 used by the terminal to receive the downlink data, and a time domain resource 4 used by the terminal to switch from a state of receiving the downlink data to a state of waiting to receive next scheduling information, where a length of the time domain resource I is denoted as T1, a length of the time domain resource 2 is denoted as T2, a length of the time domain resource 3 is denoted as T3, and a length of the time domain resource 4 is denoted as T4. Specifically, the base station may determine T1 based on a related parameter specified in a protocol, then select a smallest value from a candidate set of T2 specified in the protocol as candidate T2, determine, based on a total amount of to-be-sent downlink data, a quantity of subframes required to transmit the downlink data, and determine T3 by using the determined quantity of subframes, a quantity of repetitions of one or more subframes, and duration of the one or more subframes specified in the protocol. Then, the base station determines whether a length (denoted as T5) of a next time domain resource that is adjacent to the time domain resource 2 and that can be used to transmit the downlink data is greater than or equal to T3. If T5 is less than T3, the base station increases the candidate T2 based on the candidate set of T2 to obtain new candidate T2 (that is, determines a new time domain resource 2) until a length of a next time domain resource that is adjacent to the new time domain resource 2 and that can be used to transmit the downlink data is greater than or equal to T3. The base station determines the new candidate T2 as target T2. Finally, the base station determines T4 as specified in the protocol. In this way, the downlink transmission resource allocation is completed.

However, in the foregoing method, after the base station determines the candidate T2, if the length of the next time domain resource that is adjacent to the new time domain resource 2 and that can be used to transmit the downlink data is less than T3, the base station increases the candidate T2 until a length of a next time domain resource that is adjacent to a corresponding time domain resource 2 and that can be used to transmit the downlink data is greater than or equal to T3. Consequently, the base station may determine relatively large T2, and there may be a plurality of idle resource points (referred to as resource fragments below) on the time domain resource 2 that are not allocated to transmit the downlink data, resulting in a relatively low downlink peak rate of a cell.

### SUMMARY

This application provides a downlink transmission resource allocation method and apparatus, to increase a downlink peak rate of a cell.

To achieve the foregoing objective, the following technical solutions are used in this application.

According to a first aspect, a downlink transmission resource allocation method is provided. The method may include: determining, by a base station, a first time domain resource length and a second time domain resource length; decreasing, by the base station, the second time domain resource length if the first time domain resource length is greater than or equal to a preset threshold; and if a third time domain resource length is greater than or equal to a decreased second time domain resource length, determining, by the base station, the first time domain resource length as a first target time domain resource length, and determining, by the base station, the decreased second time domain resource length as a second target time domain resource length, where a first time domain resource is used by a terminal to switch from a first state to a second state, the first state is a state in which the terminal receives scheduling information, the second state is a state in which the terminal receives downlink data, a second time domain resource is used by the terminal to receive the downlink data, and a third time domain resource is a next time domain resource that is adjacent to the first time domain resource and that is used to transmit the downlink data.

According to the downlink transmission resource allocation method provided in this application, if the first time domain resource length is greater than or equal to the preset threshold, the base station may first decrease the second time domain resource length, and then determine whether the third time domain resource length is greater than or equal to the decreased second time domain resource length, so that the first time domain resource length can be decreased to some extent, that is, resource fragments of a downlink channel can be reduced, thereby increasing a downlink peak rate of a cell.

In a first optional implementation of the first aspect, the decreasing, by the base station, the second time domain resource length if the first time domain resource length is greater than or equal to a preset threshold may include: decreasing, by the base station, a first subframe quantity, where a decreased first subframe quantity meets: N2≤N1≤N3, N1 is the decreased first subframe quantity, N2 is a smallest value of a quantity of subframes required by the terminal to receive the downlink data, N3 is a largest value of the quantity of subframes required by the terminal to receive the downlink data, and the first subframe quantity is a quantity of subframes included in the current second time domain resource.

In this application, the base station may decrease the first subframe quantity to the specified range in a preset decreasing manner. A specific decreasing method may be flexibly determined based on an actual situation.

In a second optional implementation of the first aspect, if the third time domain resource length is less than the decreased second time domain resource length, the downlink transmission resource allocation method provided in this application may further include: increasing, by the base station, the first time domain resource length; and if a fourth time domain resource length is greater than or equal to the decreased second time domain resource length, determining, by the base station, an increased first time domain resource length as the first target time domain resource length, and determining, by the base station, the decreased second time domain resource length as the second target time domain resource length; or decreasing, by the base station, the decreased second time domain resource length if a fourth time domain resource length is less than the decreased second time domain resource length, where a fourth time domain resource is a next time domain resource that is adjacent to an increased first time domain resource and that is used to transmit the downlink data.

In this application, on one hand, if the fourth time domain resource length is greater than or equal to the decreased second time domain resource length, it indicates that after the base station increases the first time domain resource length, the next time domain resource that is adjacent to the increased first time domain resource and that can be used to transmit the downlink data meets a requirement of receiving the downlink data by the terminal. Therefore, the base station determines the increased first time domain resource length as the first target time domain resource length, and determines the decreased second time domain resource length as the second target time domain resource length, so that allocation of the first target time domain resource length and the second target time domain resource length is completed. On the other hand, if the fourth time domain resource length is less than the decreased second time domain resource length, it indicates that the next time domain resource (namely, the fourth time domain resource) that is adjacent to the increased first time domain resource and that can be used to transmit the downlink data still cannot meet the resource requirement of receiving the downlink data by the terminal. In this case, the base station continues to decrease, based on a second time domain resource after a previous decrease, the second time domain resource length.

In a third optional implementation of the first aspect, if the first time domain resource length is less than the preset threshold, the downlink transmission resource allocation method provided in this application may further include: determining, by the base station, whether the third time domain resource length is greater than or equal to the second time domain resource length; and if the third time domain resource length is greater than or equal to the second time domain resource length, determining, by the base station, the first time domain resource length as the first target time domain resource length, and determining, by the base station, the second time domain resource length as the second target time domain resource length; or increasing, by the base station, the first time domain resource length if the third time domain resource length is less than the second time domain resource length.

In this application, because the base station determines that the first time domain resource length is less than the preset threshold, the base station further determines whether the third time domain resource length is greater than or equal to the second time domain resource length. If the third time domain resource length is greater than or equal to the second time domain resource length, it indicates that the third time domain resource meets the resource requirement of receiving the downlink data by the terminal. The base station determines the first time domain resource length as the first target time domain resource length, and determines the second time domain resource length as the second target time domain resource length, so that allocation of the first time domain resource length and the second time domain resource length is completed.

In a fourth optional implementation of the first aspect, the increasing, by the base station, the first time domain resource length may include: sequentially increasing, by the base station, one or more first time domain resource lengths in ascending order based on a first time domain resource length candidate set, where the first time domain resource length candidate set includes at least one candidate first time domain resource length.

In this application, the base station may alternatively increase the first time domain resource length in another manner (for example, in an arithmetic sequence manner) based on the first time domain resource length candidate set. The manner may specifically be determined based on an actual use requirement.

According to a second aspect, a base station is provided. The base station includes a determining module and an adjustment module. The determining module may be configured to determine a first time domain resource length and a second time domain resource length, where a first time domain resource is used by a terminal to switch from a first state to a second state, the first state is a state in which the terminal receives scheduling information, the second state is a state in which the terminal receives downlink data, and a second time domain resource is used by the terminal to receive the downlink data. The adjustment module may be configured to decrease the second time domain resource length if the first time domain resource length determined by the determining module is greater than or equal to a preset threshold. The determining module may further be configured to: if a third time domain resource length is greater than or equal to a decreased second time domain resource length, determine the first time domain resource length as a first target time domain resource length, and determine the decreased second time domain resource length as a second target time domain resource length, where a third time domain resource is a next time domain resource that is adjacent to the first time domain resource and that is used to transmit the downlink data.

In a first optional implementation of the second aspect, the adjustment module is specifically configured to decrease a first subframe quantity, where a decreased first subframe quantity meets: N2≤N1≤N3, N1 is the decreased first subframe quantity, N2 is a smallest value of a quantity of subframes required by the terminal to receive the downlink data, N3 is a largest value of the quantity of subframes required by the terminal to receive the downlink data, and the first subframe quantity is a quantity of subframes included in the third time domain resource.

In a second optional implementation of the second aspect, the adjustment module may further be configured to increase the first time domain resource length if the third time domain resource length is less than the decreased second time domain resource length. The determining module may further be configured to: if a fourth time domain resource length is greater than or equal to the decreased second time domain resource length, determine an increased first time domain resource length as the first target time domain resource length, and determine the decreased second time domain resource length as the second target time domain resource length, where a fourth time domain resource is a next time domain resource that is adjacent to an increased first time domain resource and that is used to transmit the downlink data. The adjustment module may further be configured to decrease the decreased second time domain resource length if a fourth time domain resource length is less than the decreased second time domain resource length.

In a third optional implementation of the second aspect, the determining module may further be configured to: determine whether the third time domain resource length is greater than or equal to the second time domain resource length; and if the third time domain resource length is greater than or equal to the second time domain resource length, determine the first time domain resource length as the first target time domain resource length, and determine the second time domain resource length as the second target time domain resource length. The adjustment module may further be configured to increase the first time domain resource length if the third time domain resource length is less than the second time domain resource length.

In a fourth optional implementation of the second aspect, the adjustment module is specifically configured to sequentially increase one or more first time domain resource lengths in ascending order based on a first time domain resource length candidate set, where the first time domain resource length candidate set includes at least one candidate first time domain resource length.

According to a third aspect, a base station is provided. The base station includes a processor and a memory coupled to the processor. The memory is configured. to store a computer instruction, and when the base station runs, the processor executes the computer instruction stored in the memory, so that the base station performs the downlink transmission resource allocation method according to any one of the first aspect and the optional implementations of the first aspect.

According to a fourth aspect, a computer-readable storage medium is provided. The computer-readable storage medium includes a computer instruction, and when the computer instruction runs on a base station, the base station performs the downlink transmission resource allocation method according to any one of the first aspect and the optional implementations of the first aspect.

According to a fifth aspect, a computer program product including a computer instruction is provided. When the computer program product runs on a base station, the base station performs the downlink transmission resource allocation method according to any one of the first aspect and the optional implementations of the first aspect.

According to a sixth aspect, a base station is provided. The base station exists in a product form of a chip. A structure of the apparatus includes a processor and a memory. The memory is configured to be coupled to the processor. The memory may be configured to store a computer instruction. The processor is configured to execute the computer instruction stored in the memory, so that the base station performs the downlink transmission resource allocation method according to any one of the first aspect and the optional implementations of the first aspect.

For descriptions about technical effects of the second aspect to the sixth aspect, refer to the related descriptions about the technical effects of the first aspect. Details are not described herein again.

### BRIEF DESCRIPTION OF DRAWINGS

FIG. 1 is a schematic architectural diagram of a communications system according to an embodiment of the present invention;

FIG. 2 is a schematic hardware diagram of a base station according to an embodiment of the present invention;

FIG. 3 is a schematic diagram of a time domain resource according to an embodiment of the present invention;

FIG. 4 is a first schematic diagram of a downlink transmission resource allocation method according to an embodiment of the present invention;

FIG. 5 is a second schematic diagram of a downlink transmission resource allocation method according to an embodiment of the present invention;

FIG. 6A and FIG. 6B are third schematic diagrams of a downlink transmission resource allocation method according to an embodiment of the present invention;

FIG. 7A and FIG. 7B are fourth schematic diagrams of a downlink transmission resource allocation method according to an embodiment of the present invention;

FIG. 8 is a first schematic structural diagram of a base station according to an embodiment of the present invention; and

FIG. 9 is a second schematic structural diagram of a base station according to an embodiment of the present invention.

### DESCRIPTION OF EMBODIMENTS

The term “and/or” in this specification describes only an association relationship for describing associated objects and represents that three relationships may exist. For example, A and/or B may represent the following three cases: Only A exists, both A and B exist, and only B exists.

In the specification and claims in embodiments of the present invention, the terms “first”, “second”, and the like are intended to distinguish between different objects but do not indicate a particular order of the objects. For example, a first time domain resource, a second time domain resource, and the like are intended to distinguish different time domain resources but do not indicate a particular order of the time domain resources.

In the embodiments of the present invention, the word “example” or “for example” is used to represent giving an example, an illustration, or a description. Any embodiment or design scheme described as an “example” or “for example” in the embodiments of the present invention does not need to be explained as being more preferred or having more advantages than another embodiment or design scheme. Exactly, use of the word “example”, “for example”, or the like is intended to present a related concept in a specific manner.

In descriptions of the embodiments of the present invention, unless otherwise stated, “a plurality of” means two or more than two. For example, a plurality of processing units are two or more processing units. A plurality of systems are two or more systems.

Based on a problem described in the background, according to the downlink transmission resource allocation method provided in the embodiments of the present invention, a base station allocates downlink transmission resources to a terminal, so that the terminal can communicate with the base station on the downlink transmission resources allocated by the base station. This can reduce resource fragments of a downlink channel, thereby improving a downlink peak rate of a cell.

The downlink transmission resource allocation method and apparatus provided in the embodiments of the present invention may be applied to a wireless communications system. The wireless communications system may be an LTE system, an LTE-advanced (LTE-A) system, or a new radio (NR) system (namely, a 5G system), or the like. For example, the wireless communications system provided in the embodiments of the present invention is the NR system.

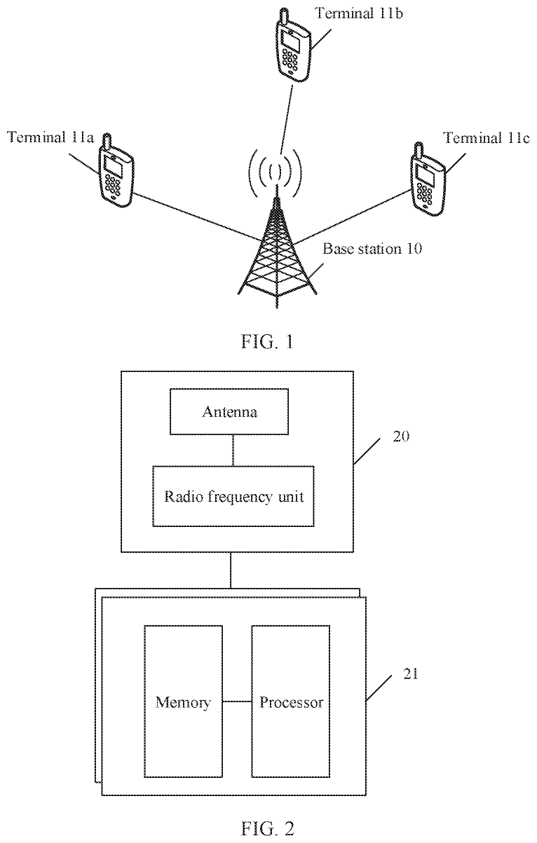

FIG. 1 is a schematic architectural diagram of an NR system according to an embodiment of the present invention. In FIG. 1, the NR system includes a base station 10 and at least one terminal (in FIG. 1, three terminals are used as an example, and are respectively denoted as a terminal 11a, a terminal 11b, and a terminal 11c). The base station 10 may communicate with the terminal 11a, the terminal 11b, or the terminal 11c by using a downlink channel or an uplink channel. The downlink transmission resource allocation method provided in the embodiments of the present invention is used to allocate downlink time domain resources to the terminal.

The base station provided in the embodiments of the present invention may be a commonly used base station, an evolved NodeB (eNB), a network device (for example, a next-generation NodeB (gNB), a new radio NodeB (new radio eNB), a macro base station, a micro base station, a high frequency base station, or a transmission and reception point (TRP)) in the NR system, or the like. For example, in the embodiments of the present invention, the commonly used base station is used as an example to describe a hardware structure of the network device. The following specifically describes components of the base station provided in the embodiments of the present invention with reference to FIG. 2. As shown in FIG. 2, the base station provided in the embodiments of the present invention may include a part 20 and a part 21. The part 20 is mainly configured to: send and receive a radio frequency signal, and perform conversion between the radio frequency signal and a baseband signal. The part 21 is mainly configured to: perform baseband processing, control the base station, and the like. The part 20 may usually be referred to as a transceiver unit, a transceiver machine, a transceiver circuit, a transceiver, or the like. The part 21 is usually a control center of the base station, or may usually be referred to as a processing unit, configured to control the base station to perform the steps performed by the base station in FIG. 2. For details, refer to the foregoing descriptions of the related parts.

The transceiver unit in the part 20 may also be referred to as a transceiver machine, a transceiver, or the like. The transceiver unit includes an antenna and a radio frequency unit. The radio frequency unit is mainly configured to perform radio frequency processing. Optionally, a component that is in the part 20 and that is configured to implement a reception function may be considered as a receiving unit, and a component that is configured to implement a transmission function may be considered as a sending unit. In other words, the part 20 includes the receiving unit and the sending unit. The receiving unit may also be referred to as a receiver, a receiver, a receiver circuit, or the like. The sending unit may be referred to as a transmitter, a transmitter circuit, or the like.

The part 21 may include one or more boards. Each board may include one or more processors and one or more memories. The processor is configured to read and execute a program in the memory, to implement a baseband processing function and control the base station. If there are a plurality of boards, the boards may be interconnected to enhance a processing capability. In an optional implementation, alternatively, the plurality of boards may share one or more processors, or the plurality of boards share one or more memories, or the plurality of boards simultaneously share one or more processors. The memory and the processor may be integrated together, or may be disposed independently. In some embodiments, the part 20 and the part 21 may be integrated together, or may be disposed independently. In addition, all functions of the part 21 may be integrated into one chip for implementation. Alternatively, some functions may be integrated into one chip for implementation and some other functions are integrated into one or more other chips for implementation. This is not limited in the embodiments of the present invention.

In the embodiments of the present invention, in a process in which the base station communicates with the terminal, the base station first sends scheduling information to the terminal, and then sends downlink data to the terminal. The terminal receives the scheduling information, switches from a state of receiving the scheduling information to a state of receiving the downlink data, and then start to receive the downlink data. Then, the terminal switches from the state of receiving the downlink data to the state of receiving the scheduling information, and waits to receive scheduling information sent by the base station next time. In the embodiments of the present invention, the base station may allocate, to the terminal, a transmission resource used to receive information (including receiving downlink scheduling information, the downlink data, and the like) on the downlink channel.

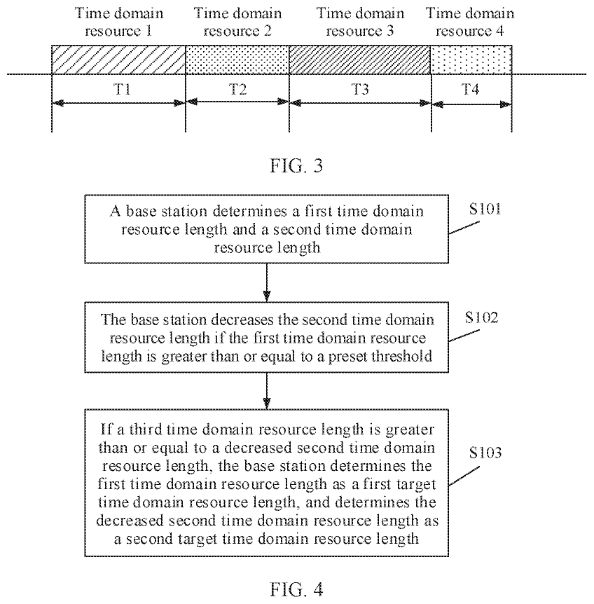

For example, as shown in FIG. 3, downlink transmission resources allocated by the base station to the terminal may include a time domain resource 1, a time domain resource 2, a time domain resource 3, and a time domain resource 4. A length of the time domain resource 1 allocated by the base station to the terminal is denoted as T1, where T1 may be understood as duration; a length of the time domain resource 2 is denoted as T2, a length of the time domain resource 3 is denoted as T3, and a length of the time domain resource 4 is denoted as T4. The time domain resource 1 of which the length is T1 is used by the terminal to receive the scheduling information sent by the base station, the time domain resource 2 of which the length is T2 is used by the terminal to switch from the state of receiving the scheduling information to the state of receiving the downlink data (that is, it may be understood that the time domain resource 2 is a resource that is reserved by the base station and that is used by the terminal to process the scheduling information), the time domain resource 3 of which the length is T3 is used to receive the downlink data sent by the base station, and the time domain resource 4 of which the length is T4 is used by the terminal to switch from the state of receiving the downlink data to a state of receiving scheduling information sent by the base station next time.

It needs to be noted that, in the embodiments of the present invention, the time domain resource 2 and the time domain resource 4 are latency that is determined by the base station and of which the terminal performs state switching, that is, waiting latency in which the terminal waits to receive the scheduling information or the downlink data, and the terminal does not use the time domain resource 2 and the time domain resource 4. The base station may allocate the time domain resource 2 and the time domain resource 4 to another terminal, so that the another terminal receives information or data.

In the embodiments of the present invention, in a process in which the terminal switches from the state of receiving the downlink data to the state of receiving the scheduling information sent by the base station next time, the terminal first switches from the state of receiving the downlink data to a state of sending uplink information (for example, sending an acknowledgment data packet of the downlink data), and then sends the uplink information to the base station. Then, the terminal switches from the state of sending the uplink information to the state of receiving the scheduling information sent by the base station next time, and waits to receive the scheduling information sent by the base station next time.

As shown in FIG. 4, a downlink transmission resource allocation method according to an embodiment of the present invention may include S101 to S103.

S101: A base station determines a first time domain resource length and a second time domain resource length.

In this embodiment of the present invention, a time domain resource length may be understood as duration. The first time domain resource length is a length of a first time domain resource, and the second time domain resource length is a length of a second time domain resource. Herein, the first time domain resource is equivalent to the time domain resource 2 shown in FIG. 3, and the second time domain resource is equivalent to the time domain resource 3 shown in FIG. 3. It may be learned that the first time domain resource is used by a terminal to switch from a first state to a second state, the first state is a state in which the terminal receives scheduling information, the second state is a state in which the terminal receives downlink data, and the second time domain resource is used by the terminal to receive the downlink data.

The determining, by the base station, the first time domain resource length in S101 may be understood as determining, by the base station, the first time domain resource length for the first time or determining, by the base station, an initial value of the first time domain resource length. In this embodiment of the present invention, an optional range of the first time domain resource length is specified in a protocol of communication between the base station and the terminal. For example, the first time domain resource length may be a sum of each element in a preset time domain resource length set and a preset length. If the preset time domain resource length set is denoted as {a₁, a₂, a₃, a₄, . . ., aₙ} and the preset length is Δ, a first time domain resource length candidate set is {Δ+a₁, Δ+a₂, Δ+a₃, Δ+a₄, . . ., Δ+aₙ}.

For example, the first time domain resource length determined by the base station for the first time may be a smallest time domain resource length in the first time domain resource length candidate set. For example, if Δ=4 ms, and the preset set is {0,4,8,12,16,32,64,128}, the first time domain resource length candidate set may be {4+0,4+4,4+8,4+12,4+16,4+32,4+64,4+128}, and the first time domain resource length determined by the base station may be 4 ms.

It needs to be noted that, in this embodiment of the present invention, the base station may determine, based on an actual situation, whether the first time domain resource length determined for the first time meets a use condition (where the use condition is described in detail in the following embodiment). If the first time domain resource length does not meet the use condition, the base station may update the first time domain resource length. A specific method may include: selecting, by the base station in ascending order, a next value from the first time domain resource length candidate set as the first time domain resource length until the first time domain resource length that meets the use condition is selected.

The determining, by the base station, the second time domain resource length in S101 may be understood as determining, by the base station, the second time domain resource length for the first time or determining, by the base station, an initial value of the second time domain resource length. In this embodiment of the present invention, the base station may determine, based on an amount of to-be-sent downlink data and a transport block size specified in a protocol, a quantity (referred to as a first subframe quantity below) of subframes used by the terminal to receive the downlink data, and then determines the second time domain resource length based on the first subframe quantity, duration of one or more subframes specified in the protocol, and a quantity of repetitions of the one or more subframes. For example, the second time domain resource length may be obtained by using the following formula:

T3=M×N×P, where

T3 is the second time domain resource length, M is the first subframe quantity, N is the duration of the one or more subframes, and P is the quantity of repetitions of the one or more subframes.

It needs to be noted that different bearer capabilities of the transport blocks may indicate different quantities (namely, first subframe quantities) of the subframes that are allocated by the base station to the terminal and that are used by the terminal to receive the downlink data. Specifically, the first subframe quantity may change within a range. For example, when a value range of the first subframe quantity is [1, 5], the first subframe quantity may be 1, 2, 3, 4, or 5. To enable the terminal to quickly receive the downlink data sent by the base station (that is, to improve a rate at which the terminal receives the downlink data), when determining the second time domain resource length for the first time, the base station determines a largest quantity of subframes as the first subframe quantity.

S102: The base station decreases the second time domain resource length if the first time domain resource length is greater than or equal to a preset threshold.

S103: If a third time domain resource length is greater than or equal to a decreased second time domain resource length, the base station determines the first time domain resource length as a first target time domain resource length, and determines the decreased second time domain resource length as a second target time domain resource length.

A third time domain resource is a next time domain resource that is adjacent to the first time domain resource and that can be used to transmit the downlink data.

In this embodiment of the present invention, if the first time domain resource length is greater than or equal to the preset threshold, the base station may first decrease the second time domain resource length, and then determine whether a length (namely, the third time domain resource length) of the next time domain resource that is adjacent to the first time domain resource and that can be used to transmit the downlink data is greater than or equal to the decreased second time domain resource length. If the third time domain resource length is greater than or equal to the decreased second time domain resource length, it indicates that when the base station allocates the second time domain resource length to the terminal, the third time domain resource adjacent to the first time domain resource can be used by the terminal to receive the downlink data (that is, the third time domain resource can meet a resource requirement of receiving the downlink data by the terminal). Therefore, the base station determines the first time domain resource length as the first target time domain resource length (namely, the length of the first time domain resource allocated by the base station to the terminal), and determines the decreased second time domain resource length as the second target time domain resource length (namely, the length of the second time domain resource allocated by the base station to the terminal).

It may be understood that, in S101, the use condition that the first time domain resource length needs to meet is: The length (namely, the third time domain resource length) of the next time domain resource that is adjacent to the first time domain resource and that can be used to transmit the downlink data is greater than or equal to the decreased second time domain resource length.

It needs to be noted that, in this embodiment of the present invention, the preset threshold of the first time domain resource length may be determined based on an actual situation (for example, may be 12 ms). This is not specifically limited in the embodiments of the present invention.

According to the downlink transmission resource allocation method provided in this embodiment of the present invention, the base station determines the first time domain resource length and the second time domain resource length, and then decreases the second time domain resource length if the first time domain resource length is greater than or equal to the preset threshold. In addition, if the length (namely, the third time domain resource length) of the next time domain resource that is adjacent to the first time domain resource and that can be used to transmit the downlink data is greater than or equal to the decreased second time domain resource length, the base station determines the first time domain resource length as the first target time domain resource length, and determines the decreased second time domain resource length as the second target time domain resource length. Compared with the prior art, in this embodiment, if the first time domain resource length is greater than or equal to the preset threshold, the base station may first decrease the second time domain resource length, and then determine whether the third time domain resource length is greater than or equal to the decreased second time domain resource length, so that the first time domain resource length can be decreased to some extent, that is, resource fragments of a downlink channel can be reduced, thereby increasing a downlink peak rate of a cell.

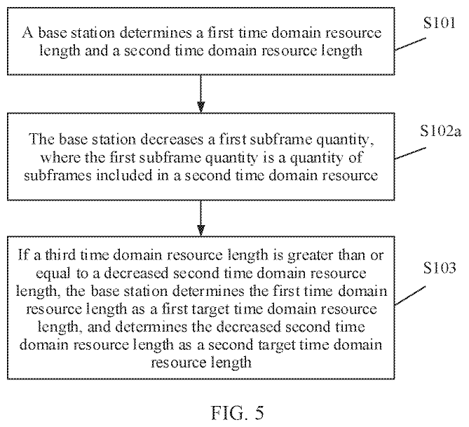

Optionally, with reference to FIG. 4, as shown in FIG. 5, S102 may specifically be implemented by performing S102a.

S102a: The base station decreases the first subframe quantity, where the first subframe quantity is a quantity of subframes included in the second time domain resource.

In this embodiment of the present invention, a decreased first subframe quantity meets the following condition:

N2≤N1≤N3, where

N1 is the decreased first subframe quantity, N2 is a smallest value of a quantity of subframes required by the terminal to receive the downlink data, and N3 is a largest value of the quantity of subframes required by the terminal to receive the downlink data. That is, the decreasing the first subframe quantity may be understood as decreasing the first subframe quantity within a value range of the first subframe quantity.

Optionally, in this embodiment of the present invention, when the first subframe quantity is decreased, the first subframe quantity may be decreased in a preset decreasing manner. For example, the base station may decrease the first subframe quantity one by one within the value range of the first subframe quantity. For example, the value range of the first subframe quantity is [1, 5], and a current first subframe quantity is 4. The decreasing, by the base station, the first subframe quantity this time is specifically decreasing, by the base station, the first subframe quantity by 1, and a decreased first subframe quantity is 3.

The first subframe quantity may alternatively be decreased in another manner, and may be specifically determined based on an actual use requirement. This is not limited in the embodiments of the present invention.

In this embodiment of the present invention, before determining the first time domain resource length, the base station may further determine a third target time domain resource length, where a third target time domain resource is used by the terminal to receive the scheduling information sent by the base station (the third target time domain resource herein is equivalent to the time domain resource 1 shown in FIG. 3). After determining the second target time domain resource length, the base station may further determine a fourth target time domain resource length, where a fourth target time domain resource is used by the terminal to switch from the second state to the first state (the fourth target time domain resource herein is equivalent to the time domain resource 4 shown in FIG. 3).

The following is a complete process in which the base station determines the third target time domain resource length, the first target time domain resource length, the second target time domain resource length, and the fourth target time domain resource length, to describe the downlink transmission resource allocation method provided in the embodiments of the present invention in detail.

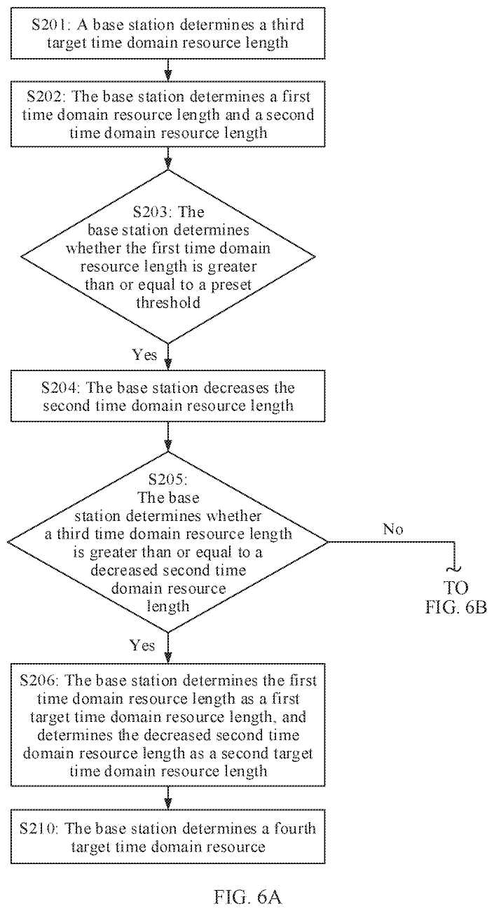

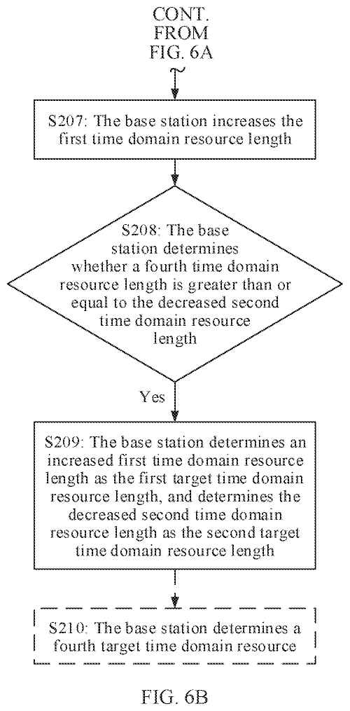

As shown in FIG. 6A and FIG. 6B, a downlink transmission resource allocation method according to an embodiment of the present invention may include the following steps.

S201: A base station determines a third target time domain resource length.

In this embodiment of the present invention, the base station may determine the third target time domain resource length as specified in a communication protocol. Specifically, the base station determines the third target time domain resource length based on a related parameter specified in a communication protocol, for example, a largest quantity of repetitions (namely, Rmax in the protocol), a current quantity of repetitions (namely, R in the protocol), and a period factor (namely, G in the protocol), and may determine a starting position of a third target time domain resource.

S202: The base station determines a first time domain resource length and a second time domain resource length.

For a specific description of S202, refer to the related description of S101 in the foregoing embodiment. Details are not described herein again.

S203: The base station determines whether the first time domain resource length is greater than or equal to a preset threshold.

For a description of the preset threshold, refer to the related description of the preset threshold in the foregoing embodiment. Details are not described herein again.

In this embodiment of the present invention, after determining the first time domain resource length, the base station may determine whether the first time domain resource length is greater than or equal to the preset threshold, so that the base station performs corresponding processing based on a determined result. Specifically, if the first time domain resource length is greater than or equal to the preset threshold, the base station performs S204.

S204: The base station decreases the second time domain resource length.

For a specific description of S204, refer to the related description of S102 (including S102a) in the foregoing embodiment. Details are not described herein again.

S205: The base station determines whether a third time domain resource length is greater than or equal to a decreased second time domain resource length.

In this embodiment of the present invention, the determining, by the base station, whether a next available time domain resource (namely, the third time domain resource) adjacent to the first time domain resource can meet a resource requirement of receiving downlink data by a terminal may be specifically implemented by determining whether the third time domain resource length is greater than or equal to the decreased second time domain resource length. If the third time domain resource length is greater than or equal to the decreased second time domain resource length, it indicates that when the base station allocates the decreased second time domain resource length to the terminal, the third time domain resource adjacent to the first time domain resource can be used by the terminal to receive the downlink data (that is, the third time domain resource can meet the resource requirement of receiving the downlink data by the terminal); or if the third time domain resource length is less than the decreased second time domain resource length, it indicates that when the base station allocates the decreased second time domain resource length to the terminal, the third time domain resource adjacent to the first time domain resource cannot be used by the terminal to receive the downlink data (that is, the third time domain resource cannot meet the resource requirement of receiving the downlink data by the terminal).

In this embodiment of the present invention, if the third time domain resource length is greater than or equal to the decreased second time domain resource length, the base station performs S206.

S206: The base station determines the first time domain resource length as a first target time domain resource length, and determines the decreased second time domain resource length as a second target time domain resource length.

In this embodiment of the present invention, after the base station decreases the second time domain resource, a next time domain resource that is adjacent to the first time domain resource and that can be used to transmit the downlink data meets the resource requirement of receiving the downlink data by the terminal. Therefore, the base station may determine the determined first time domain resource length as the first target time domain resource length, and determine the decreased second time domain resource length as the second target time domain resource length, so that allocation of the first target time domain resource length and the second target time domain resource length is completed.

If the third time domain resource length is less than the decreased second. time domain resource length, the base station performs S207.

S207: The base station increases the first time domain resource length.

In this embodiment of the present invention, if after the base station decreases the second time domain resource, the next time domain resource that is adjacent to the first time domain resource and that can be used. to transmit the downlink data still cannot meet the resource requirement of receiving the downlink data by the terminal, the base station increases the first time domain resource length, and then determines whether a next time domain resource that is adjacent to an increased first time domain resource and that can be used to transmit the downlink data meets the resource requirement of receiving the downlink data by the terminal.

Optionally, in this embodiment of the present invention, the method for increasing the first time domain resource by the base station may include S207a.

S207a: The base station sequentially increases one or more first time domain resource lengths in ascending order based on a first time domain resource length candidate set.

The first time domain resource length candidate set includes at least one candidate first time domain resource length.

For a description of the first time domain resource length candidate set, refer to the related description of the first time domain resource length candidate set in S101. Details are not described herein again.

For example, the method for increasing the first time domain resource length by the base station may be as follows: If the first time domain resource length candidate set is {4+0,4+4,4+8,4+12,4+16,4+32,4+64,4+128}, a current first time domain resource length is 4, and the base station sequentially increases the first time domain resource lengths in the first time domain resource length candidate set in ascending order, a first time domain resource length increased this time is a next value of 4, that is, an increased first time domain resource length is 8.

It needs to be noted that, in this embodiment of the present invention, the base station may alternatively increase the first time domain resource length in another manner (for example, in an arithmetic sequence manner) based on the first time domain resource length candidate set. The manner may specifically be determined based on an actual use requirement. This is not limited in the embodiments of the present invention.

In an optional implementation, if the third time domain resource length is less than the decreased second time domain resource length, the base station may re-determine the third target time domain resource length (that is, the base station repeats step S201), adjust the third time domain resource length or a starting position of the third time domain resource, and then increase the first time domain resource length.

S208: The base station determines whether a fourth time domain resource length is greater than or equal to the decreased second time domain resource length.

A fourth time domain resource is the next time domain resource that is adjacent to the increased first time domain resource and that can be used to transmit the downlink data.

Similar to S205, in this embodiment of the present invention, after increasing the first time domain resource length, the base station determines whether a length (namely, the fourth time domain resource length) of the next time domain resource that is adjacent to the increased first time domain resource and that can be used to transmit the downlink data is greater than or equal to the decreased second time domain resource length, to determine whether the fourth time domain resource meets the resource requirement of receiving the downlink data by the terminal.

In this embodiment of the present invention, if the fourth time domain resource length is greater than or equal to the decreased second time domain resource length, the base station performs S209.

S209: The base station determines the increased first time domain resource length as the first target time domain resource length, and determines the decreased second time domain resource length as the second target time domain resource length.

Similar to S206, in S209, after the base station increases the first time domain resource length, the next time domain resource that is adjacent to the increased first time domain resource and that can be used to transmit the downlink data meets a requirement of receiving the downlink data by the terminal. Therefore, the base station determines the increased first time domain resource length as the first target time domain resource length, and determines the decreased second time domain resource length as the second target time domain resource length, so that allocation of the first target time domain resource length and the second target time domain resource length is completed.

In this embodiment of the present invention, if the fourth time domain resource length is less than the decreased second time domain resource length, the base station returns to S204, and repeats related steps. A difference from S204 (the base station decreases the second time domain resource length) is that the base station continues to decrease the decreased second time domain resource length.

In this embodiment of the present invention, after the base station increases the first time domain resource length, if the next time domain resource (namely, the fourth time domain resource) that is adjacent to the increased first time domain resource and that can be used to transmit the downlink data still cannot meet the resource requirement of receiving the downlink data by the terminal, the base station continues to decrease, based on a second time domain resource after a previous decrease, the second time domain resource length (a second time domain resource length after the second decrease may be referred to as a second time domain resource length after two decreases below), and then determines whether the fourth time domain resource length is greater than or equal to the second time domain resource length after two decreases. In this way, a decrease of the second time domain resource length and an increase of the first time domain resource length are performed in an alternate iteration manner until a length of a next time domain resource that is adjacent to a current first time domain resource (which may be understood as a current first time domain resource of which a length is increased for a plurality of times) and that can be used to transmit the downlink data is greater than or equal to a current second time domain resource length (which may be understood as a current second time domain resource length after a plurality of decreases). The base station determines the current first time domain resource length as the first target time domain resource length, and determines the current second time domain resource length as the second target time domain resource length.

In this embodiment of the present invention, in S203, if the base station determines that the first time domain resource length is less than the preset threshold, the base station further determines whether the third time domain resource length is greater than or equal to the second time domain resource length. If the third time domain resource length is greater than or equal to the second time domain resource length, it indicates that the third time domain resource meets the resource requirement of receiving the downlink data by the terminal. The base station determines the first time domain resource length as the first target time domain resource length, and determines the second time domain resource length as the second target time domain resource length, so that allocation of the first time domain resource length and the second time domain resource length is completed.

If the third time domain resource length is less than the second time domain resource length, the base station increases the first time domain resource length, and repeatedly performs a step similar to S208. In this way, a decrease of the second time domain resource length and an increase of the first time domain resource length are performed in an alternate iteration manner until a length of a next time domain resource that is adjacent to a current first time domain resource (which may be understood as a current first time domain resource of which a length is increased for a plurality of times) and that can be used to transmit the downlink data. is greater than or equal to a current second time domain resource length (which may be understood as a current second time domain resource length after a plurality of decreases). The base station determines the current first time domain resource length as the first target time domain resource length, and determines the current second time domain resource length as the second target time domain resource length.

It may be learned that, in S203, if the base station determines that the first time domain resource length is less than the preset threshold, related steps performed by the base station are similar to S205 and related steps performed after S205. A difference from S205 (the base station determines whether the third time domain resource length is greater than or equal to the decreased second time domain resource length) is that the base station determines whether the third time domain resource length is greater than or equal to the second time domain resource length if determining that the first time domain resource length is less than the preset threshold.

In this embodiment of the present invention, after the base station determines a first target time domain resource and a second target time domain resource, the base station performs S210.

S210: The base station determines a fourth target time domain resource.

In this embodiment of the present invention, the base station may determine, as specified in the communication protocol, the fourth target time domain resource used by the terminal to switch from a second state to a first state.

It needs to be noted that, in this embodiment of the present invention, after determining the first target time domain resource and the second target time domain resource, the base station performs S210, that is, S210 can be performed after S206 or S209.

After allocating the third target time domain resource, the first target time domain resource, the second target time domain resource, and the fourth target time domain resource to the terminal, the base station completes allocating downlink transmission resources to the terminal. The base station first sends scheduling information to the terminal, where the scheduling information includes downlink transmission resource configuration information (the downlink transmission resource configuration information indicates the downlink transmission resources allocated by the base station to the terminal), and then sends the downlink data to the terminal, so that the terminal receives, based on the downlink transmission resources allocated by the base station to the terminal, the scheduling information and the downlink data that are sent by the base station.

In this embodiment of the present invention, the base station may allocate downlink transmission resources to all terminals in a cell by using the foregoing downlink transmission resource allocation method. When the first time domain resource length is greater than the preset threshold, the base station first appropriately decreases the second time domain resource length (which may be understood as reversely adjusting (decreasing) the second time domain resource length in a preferred manner). When the length of the next time domain resource adjacent to the first time domain resource is greater than or equal to the decreased second time domain resource length, the base station determines the first time domain resource length as the first target time domain resource length, and determines the decreased second time domain resource length as the second target time domain resource length. When the length of the next time domain resource adjacent to the first time domain resource is less than the decreased second time domain resource length, the base station increases the first time domain resource length. Compared with the prior art, in this embodiment, the base station determines the first target time domain resource and the second target time domain resource by performing a decrease of the second time domain resource and an increase of the first time domain resource in an alternate iteration manner, so that the first time domain resource length can be decreased to some extent (that is, the first time domain resource length is not always increased when the length of the next time domain resource adjacent to the first time domain resource is less than the second time domain resource length), thereby reducing resource fragments of a downlink channel. In this way, a downlink peak rate of an entire cell can be increased, so that resource utilization of the downlink channel can be improved, and average data transmission duration of the terminal in the cell can be decreased, to reduce power consumption of the terminal.

In the foregoing embodiment, the base station determines, based on different determining conditions, whether to increase the first time domain resource length or whether to decrease the second time domain resource length. It may be understood that, the first time domain resource length (for example, the unchanged first time domain resource length or the increased first time domain resource length in the foregoing embodiment) determined after the base station determines whether to increase the first time domain resource length may be referred to as the current first time domain resource length; a length (for example, the third time domain resource length or the fourth time domain resource length in the foregoing embodiment) of the next time domain resource that is adjacent to the current first time domain resource and that can be used to transmit the downlink data may be referred to as the current third time domain resource length; and the second time domain resource length (the second time domain resource length or the decreased second time domain resource length) determined after the base station determines whether to decrease the second time domain resource length may be referred to as the current second time domain resource length.

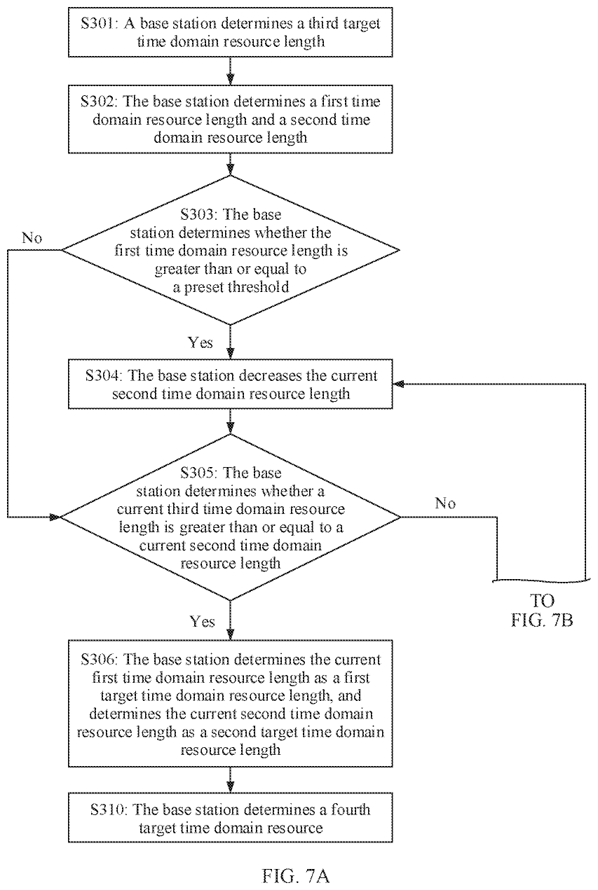

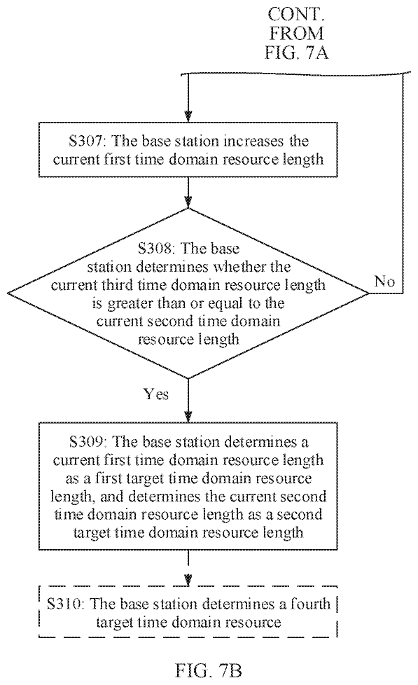

Based on the above, as shown in FIG. 7A and FIG. 7B, a downlink transmission resource allocation method according to an embodiment of the present invention may include the following steps.

S301: A base station determines a third target time domain resource length.

S302: The base station determines a first time domain resource length and a second time domain resource length.

S303: The base station determines whether the first time domain resource length is greater than or equal to a preset threshold.

In this embodiment of the present invention, if the first time domain resource length is greater than or equal to the preset threshold, the base station performs S304.

S304: The base station decreases the current second time domain resource length.

S305: The base station determines whether a current third time domain resource length is greater than or equal to a current second time domain resource length.

In this embodiment of the present invention, the current second time domain resource length in S305 is a second time domain resource length obtained by decreasing the current second time domain resource length in S304. If the current third time domain resource length is greater than or equal to the current second time domain resource length, the base station performs S306.

S306: The base station determines the current first time domain resource length as a first target time domain resource length, and determines the current second time domain resource length as a second target time domain resource length.

If the current third time domain resource length is less than the current second time domain resource length, the base station performs S307.

S307: The base station increases the current first time domain resource length.

S308: The base station determines whether the current third time domain resource length is greater than or equal to the current second time domain resource length.

In this embodiment of the present invention, if the current third time domain resource length is greater than or equal to the current second time domain resource length, the base station performs S309.

S309: The base station determines a current first time domain resource length as the first target time domain resource length, and determines the current second time domain resource length as the second target time domain resource length.

In this embodiment of the present invention, if the current third time domain resource length is less than the current second time domain resource length, the base station returns to S304.

In this embodiment of the present invention, in S303, if the base station determines that the first time domain resource length is less than the preset threshold, the base station performs S305.

After the base station determines a first target time domain resource and a second target time domain resource, the base station performs S310.

S310: The base station determines a fourth target time domain resource.

It needs to be noted that, in this embodiment of the present invention, after determining the first target time domain resource and the second target time domain resource, the base station performs S310. that is, S310 can be performed after S306 or S309.

For specific descriptions of S301 to S310, refer to the related description of S201 to S210 in the foregoing embodiment. Details are not described herein again.

The solutions provided in the embodiments of the present invention are described above mainly from a perspective of a network element. It may be understood that, to implement the foregoing functions, the network element such as the base station in the embodiments of the present invention includes corresponding hardware structures and/or software modules for performing the functions. A person skilled in the art needs to easily be aware that, in combination with units and algorithm steps in the examples described in the embodiments disclosed in this specification, the embodiments of the present invention may be implemented by hardware or a combination of hardware and computer software. Whether a. function is performed by hardware or hardware driven by computer software depends on particular applications and design constraint conditions of the technical solutions. A person skilled in the art may use different methods to implement the described functions for each particular application, but it does not need to be considered that the implementation goes beyond the scope of this application.

In the embodiments of the present invention, functional modules of the base station may be obtained through division according to the foregoing method examples. For example, the functional modules may be obtained through division corresponding to various functions, or two or more functions may be integrated into one processing module. The integrated module may be implemented in a form of hardware, or may be implemented in a form of a software functional module. It needs to be noted that, in the embodiments of the present invention, module division is an example, and is merely logical function division. During actual implementation, another division manner may be used.

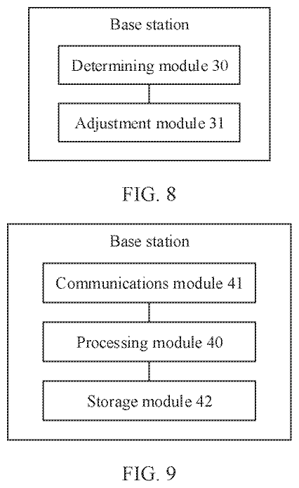

When the functional modules are obtained through division corresponding to the functions, FIG. 8 is a possible schematic structural diagram of a base station in the foregoing embodiment. As shown in FIG. 8, the base station may include a determining module 30 and an adjustment module 31. The determining module 30 may be configured to support the base station in performing S101, S103, S201 to S203, S205, S206, S208 to S210, S301 to S303, S305, S306, and S308 to S310 in the foregoing method embodiments. The adjustment module 31 may be configured to support the base station in performing S102 (including S102a), S204, S207 (including S207a), S304, and S307 in the foregoing method embodiments. All related content of the steps in the foregoing method embodiments may be cited in function descriptions of corresponding functional modules. Details are not described herein again.

When an integrated unit is used, FIG. 9 is a possible schematic structural diagram of a base station in the foregoing embodiment. As shown in FIG. 9, the base station may include a processing module 40 and a communications module 41. The processing module 40 may be configured to control and manage an operation of the base station. For example, the processing module 40 may be configured to support the base station in performing S101 to S103, S201 to S210, and S301 to S310 in the foregoing method embodiments, and/or another process of the technology described in this specification. The communications module 41 may be configured to support communication between the base station and another network entity. Optionally, as shown in FIG. 9, the base station may further include a storage module 42, configured to store program code and data of the base station.

The processing module 40 may be a processor or a controller (for example, may be the processor shown in FIG. 2). For example, the processing module 40 may be a central processing unit (CPU), a general processor, a digital signal processor (DSP), an application-specific integrated circuit (ASIC), a field programmable gate array (FPGA), or another programmable logic device, a transistor logic device, a hardware component, or any combination thereof. The processing module 40 may implement or execute various example logical blocks, modules, and circuits described with reference to content disclosed in the embodiments of the present invention. The processor may alternatively be a combination of processors implementing a computing function, for example, a combination of one or more microprocessors, or a combination of a DSP and a microprocessor. The communications module 41 may be a transceiver, a transceiver circuit, a communications interface, or the like (for example, may be the radio frequency unit shown in FIG. 2). The storage module 42 may be a memory.

When the processing module 40 is a processor, the communications module 41 is a transceiver, and the storage module 42 is a memory, the processor, the transceiver, and the memory may be connected by using a bus. The bus may be a peripheral component interconnect (PCI) bus, an extended industry standard architecture (EISA) bus, or the like. The bus may be classified into an address bus, a data bus, a control bus, and the like.

All or some of the foregoing embodiments may be implemented by using software, hardware, firmware, or any combination thereof. When a software program is used to implement the embodiments, all or some of the embodiments may be implemented in a form of a computer program product. The computer program product includes one or more computer instructions. When the computer instructions are loaded and executed on a computer, all or some of the procedures or functions according to the embodiments of the present invention are generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, such as a server or a data center, integrating one or more usable media, The usable medium may be a magnetic medium (for example, a floppy disk, a magnetic disk, or a magnetic tape), an optical medium (for example, a digital video disc (DVD)), a semiconductor medium. (for example, a solid-state drive (SSD)), or the like.

According to the foregoing descriptions of the implementations, a person skilled in the art may clearly understand. that, for the purpose of convenient and brief description, only division into the foregoing functional modules is used as an example for description. During an actual application, the foregoing functions may be allocated to different functional modules and implemented based on a requirement. In other words, an inner structure of an apparatus is divided into different functional modules, to implement all or some of the functions described above. For a detailed working process of the foregoing system, apparatus, and unit, refer to a corresponding process in the foregoing method embodiments. Details are not described herein again.

In the several embodiments provided in this application, it needs to be understood that the disclosed system, apparatus, and method may be implemented in other manners, For example, the foregoing apparatus embodiments are merely an example. For example, the module or unit division is merely logical function division. During actual implementation, another division manner may be used. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may or may not be physically separate, and components displayed as units may or may not be physical units, that is, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold. or used as an independent product, the integrated unit may be stored in a computer-readable storage medium. Based on such an understanding, the technical solutions of this application essentially, or the part contributing to the prior art, or all or some of the technical solutions may be implemented in the form of a software product. The computer software product is stored in a storage medium and includes several instructions for instructing a computer device (which may be a personal computer, a server, or a network device) or a processor to perform all or some of the steps of the method according to the embodiments of this application. The foregoing storage medium includes: any medium that can store program code, such as a flash memory, a removable hard disk, a read-only memory, a random access memory, a magnetic disk, or an optical disc.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

What is claimed is:

1. A downlink transmission resource allocation method, comprising:
determining, by a base station, a first time domain resource length and a second time domain resource length, wherein a first time domain resource is used by a terminal to switch from a first state to a second state, the first state is a state in which the terminal receives scheduling information, the second state is a state in which the terminal receives downlink data, and a second time domain resource is used by the terminal to receive the downlink data;
decreasing, by the base station, the second time domain resource length if the first time domain resource length is greater than or equal to a preset threshold; and
if a third time domain resource length is greater than or equal to a decreased second time domain resource length:
determining, by the base station, the first time domain resource length as a first target time domain resource length; and
determining, by the base station, the decreased second time domain resource length as a second target time domain resource length, wherein a third time domain resource is a next time domain resource that is adjacent to the first time domain resource and that is used to transmit the downlink data.

2. The method according to claim 1, wherein the decreasing, by the base station, the second time domain resource length if the first time domain resource length is greater than or equal to a preset threshold comprises:
decreasing, by the base station, a first subframe quantity, wherein the decreased first subframe quantity meets a condition: N2≤N1≤N3, where N1 is the decreased first subframe quantity, N2 is a smallest value of a quantity of subframes required by the terminal to receive the downlink data, and N3 is a largest value of the quantity of subframes required by the terminal to receive the downlink data, and wherein the first subframe quantity is a quantity of subframes comprised in a current second time domain resource.

3. The method according to claim 1 wherein if the third time domain resource length is less than the decreased second time domain resource length, the method further comprises:
increasing, by the base station, the first time domain resource length; and
if a fourth time domain resource length is greater than or equal to the decreased second time domain resource length:
determining, by the base station, the increased first time domain resource length as the first target time domain resource length; and
determining, by the base station, the decreased second time domain resource length as the second target time domain resource length, wherein a fourth time domain resource is a next time domain resource that is adjacent to an increased first time domain resource and that is used to transmit the downlink data; or
decreasing, by the base station, the decreased second time domain resource length if a fourth time domain resource length is less than the decreased second time domain resource length.

4. The method according to claim 1, wherein if the first time domain resource length is less than the preset threshold, the method further comprises:
determining, by the base station, whether the third time domain resource length is greater than or equal to the second time domain resource length; and
if the third time domain resource length is greater than or equal to the second time domain resource length:
determining, by the base station, the first time domain resource length as the first target time domain resource length; and
determining, by the base station, the second time domain resource length as the second target time domain resource length; or
increasing, by the base station, the first time domain resource length if the third time domain resource length is less than the second time domain resource length.

5. The method according to claim 3, wherein the increasing, by the base station, the first time domain resource length comprises:
sequentially increasing, by the base station, one or more first time domain resource lengths in ascending order based on a first time domain resource length candidate set, wherein the first time domain resource length candidate set comprises at least one candidate first time domain resource length.

6. A base station, comprising:
at least one processor;
a non-transitory computer-readable storage medium coupled to the at least one processor and storing programming instructions for execution by the at least one processor, wherein the programming instructions instruct the at least one processor to:
determine a first time domain resource length and a second time domain resource length, wherein a first time domain resource is used by a terminal to switch from a first state to a second state, the first state is a state in which the terminal receives scheduling information, the second state is a state in which the terminal receives downlink data, and a second time domain resource is used by the terminal to receive the downlink data;
decrease the second time domain resource length if the first time domain resource length is greater than or equal to a preset threshold; and
if a third time domain resource length is greater than or equal to a decreased second time domain resource length:
determine the first time domain resource length as a first target time domain resource length; and
determine the decreased second time domain resource length as a second target time domain resource length, wherein a third time domain resource is a next time domain resource that is adjacent to the first time domain resource and that is used to transmit the downlink data.

7. The base station according to claim 6, wherein the programming instructions further instruct the at least one processor to:
decrease a first subframe quantity, wherein the decreased. first subframe quantity meets a condition: N2≤N1≤N3, where Ni is the decreased first subframe quantity, N2 is a smallest value of a quantity of subframes required by the terminal to receive the downlink data, and N3 is a largest value of the quantity of subframes required by the terminal to receive the downlink data, and wherein the first subframe quantity is a quantity of subframes comprised in the third time domain resource.

8. The base station according to claim 6, wherein the programming instructions further instruct the at least one processor to:
increase the first time domain resource length if the third time domain resource length is less than the decreased second time domain resource length; and
if a fourth time domain resource length is greater than or equal to the decreased second time domain resource length:
determine the increased first time domain resource length as the first target time domain resource length; and
determine the decreased second time domain resource length as the second target time domain resource length, wherein a fourth time domain resource is a next time domain resource that is adjacent to an increased first time domain resource and that is used to transmit the downlink data; or
decrease the decreased second time domain resource length if a fourth time domain resource length is less than the decreased second time domain resource length.

9. The base station according to claim 6, wherein the programming instructions further instruct the at least one processor to:
determine whether the third time domain resource length is greater than or equal to the second time domain resource length; and
if the third time domain resource length is greater than or equal to the second time domain resource length:
determine the first time domain resource length as the first target time domain resource length; and
determine the second time domain resource length as the second target time domain resource length; or
increase the first time domain resource length if the third time domain resource length is less than the second time domain resource length.

10. The base station according to claim 8, wherein the programming instructions further instruct the at least one processor to:
sequentially increase one or more first time domain resource lengths in ascending order based on a first time domain resource length candidate set, wherein the first time domain resource length candidate set comprises at least one candidate first time domain resource length.

11. A non-transitory, computer-readable storage medium storing one or more instructions executable by a base station to perform operations comprising:
determining, by a base station, a first time domain resource length and a second time domain resource length, wherein a first time domain resource is used by a terminal to switch from a first state to a second state, the first state is a state in which the terminal receives scheduling information, the second state is a state in which the terminal receives downlink data, and a second time domain resource is used by the terminal to receive the downlink data;
decreasing, by the base station, the second time domain resource length if the first time domain resource length is greater than or equal to a preset threshold; and
if a third time domain resource length is greater than or equal to a decreased second time domain resource length:
determining, by the base station, the first time domain resource length as a first target time domain resource length; and
determining, by the base station, the decreased second time domain resource length as a second target time domain resource length, wherein a third time domain resource is a next time domain resource that is adjacent to the first time domain resource and that is used to transmit the downlink data.
